(19) United States
(12) Patent Application Publication
(10) Pub. No.: US 2024/0086902 A1
(43) Pub. Date: Mar. 14, 2024

(54) ROBOTIC SHOE CLEANING SYSTEM FOR IMPROVED RETAIL ENGAGEMENT

(71) Applicant: NIKE, Inc., Beaverton, OR (US)

(72) Inventors: Christopher Andon, Portland, OR (US); Noah Murphy-Reinhertz, Portland, OR (US); James Zormeir, Portland, OR (US); Julian Ingur Johannes Boettger, Berlin (DE); Florian Jasper Thorge Born, Berlin (DE); José Francisco Martins Damasceno Costa, Munich (DE); Adrien Yves Pierre Hobt, Berlin (DE); Markus Kison, Berlin (DE); Moritz Jules Koch, Berlin (DE); Christian Kokott, Berlin (DE); Dev Mishra, Berlin (DE)

(73) Assignee: NIKE, Inc., Beaverton, OR (US)

(21) Appl. No.: 18/463,606

(22) Filed: Sep. 8, 2023

Related U.S. Application Data
(60) Provisional application No. 63/405,280, filed on Sep. 9, 2022.

(51) Int. Cl. G06Q 20/36; G05B 19/4155

(52) U.S. Cl. CPC G06Q 20/3678; G05B 19/4155; G05B 2219/45082

(57) ABSTRACT

A method of retail engagement includes receiving a worn article from a user in a retail establishment, where the worn article includes dirt or debris on an outer surface of the article. The method then includes robotically cleaning the worn article to at least partially remove the dirt or debris on the outer surface. The cleaning comprises contacting the shoe with a rotating brush, and at least one of the worn article or the rotating brush is robotically manipulated to cause the contacting. Finally, the outer surface of the article may be adorned with one or more adornments, where the one or more adornments are selected by the user.

### CROSS REFERENCE TO RELATED APPLICATIONS

The present application claims the benefit of priority from U.S. Provisional Patent Application No. 63/405,280, filed 9 Sep. 2022, which is incorporated by reference in its entirety and for all that it discloses.

### TECHNICAL FIELD

The present disclosure generally relates to interactive robotic systems for increasing retail engagement though an automated shoe-cleaning process. Further, aspects of this disclosure relate to the distribution of cryptographically secured digital collectables through the cleaning process.

### BACKGROUND

In recent years, through the advent of online shopping, consumer product companies have experienced a decline in foot traffic/customer presence within physical retail stores. This transition to online shopping has been further accelerated and fueled by health and safety concerns in the wake of the SARS-CoV-2 pandemic. Despite a reduction in the persistent health and safety concerns stemming from the pandemic, the convenience of online shopping and/or curbside order pickup has remained popular, and the in-store customer presence has been slow to return to prior levels. As such, there is a new need for physical retail establishments to provide unique in-store experiences that can provide value to the consumer while bringing customers back into physical stores.

Aspects of the present disclosure discuss the use of digital collectables and/or non-fungible tokens (NFTs). In general, an NFT is a unique (i.e., non-fungible) digital record that is electronically stored and is capable of being sold or traded between different market participants. In many instances, an NFT can serve as a digital certificate of authenticity or proof of ownership in a corresponding digital or physical item (e.g., a “digital collectable”). The records comprising the NFT are often stored in/on an immutable digital ledger, such as a blockchain-style ledger, which can be broken up across many different nodes or ledger-maintaining participants. Such blockchain ledgers will typically use some means of cryptology to encode at least a portion of the contents of the record, while also referencing the prior block (in the chain of blocks) to provide continuity. Where appropriate within this disclosure, any mention of an NFT should be inclusively read to include any virtual good, virtual collectable, digital collectable, or the like, regardless of whether such digital item is recorded to a public blockchain, a private blockchain, or to a distributed or centralized database.

NFTs typically include resident data, referred to as metadata, that is stored directly on the blockchain. Due to cost complexities associated with pushing large quantities of data through the transaction validation process, the metadata may often include a pointer or reference to off-chain data/digital files such as photos, graphics, videos, and/or audio that would be cost-prohibitive to store on-chain. When the NFT is displayed, such as on a user's social media account or in a user's digital wallet, an associated software program may review the metadata, and then digitally retrieve the associated photo from the referenced file repository for display. It is often these photos or models that are viewed as the “digital collectable,” with its authenticity or ownership verified through the blockchain registration (i.e., a cryptographically secured digital image or model).

### BRIEF DESCRIPTION OF THE DRAWINGS

FIG. 1 is a schematic diagram of a system for cleaning and/or rehabilitating an article of footwear.

FIG. 2 is a schematic illustration of an imaging station such as may be used with the system of FIG. 1.

FIG. 3A is a schematic illustration of a dry brushing station with a first brush/bristle type, which may be used with the system of FIG. 1.

FIG. 3B is a schematic illustration of a dry brushing station with a second brush/bristle type, which may be used with the system of FIG. 1.

FIG. 4 is a schematic illustration of a drying station such as may be used with the system of FIG. 1.

FIG. 5 is a schematic flow diagram of a method of retail engagement via an automated shoe cleaning process.

FIG. 6 is a schematic flow diagram of a user interface guiding the placement and selection of one or more visual adornments on a virtual and corresponding physical shoe.

FIG. 7 is a schematic flow diagram of a method of distributing a digital collectible following the cleaning and/or adornment of an article of footwear.

FIG. 8 is a schematic diagram of a cryptographically secured digital collectable being imported into a virtual environment.

FIG. 9 is a schematic perspective view of a system for cleaning and/or rehabilitating and/or adorning an article of footwear.

FIG. 10 is a schematic side view of a robotic applicator for applying an adornment to an article of footwear.

FIG. 11 is a schematic diagram of an NFT token-gated system for cleaning an article of footwear.

FIG. 12 is a schematic perspective view of a robotic cleaning tool that utilizes shoe-lace materials as bristles.

### DETAILED DESCRIPTION

The present disclosure generally relates to a system for increasing retail engagement via the automated cleaning, refurbishing, and/or ordaining an article of footwear. These systems/methods are believed to provide an interactive experience to in-person consumers, which create a draw into physical retail establishments while also increasing the dwell times that a consumer spends in a particular area or store. For this reason, the present technology may be mutually beneficial to both the consumer and the establishment.

As will be discussed herein, the present systems and methods use a combination of imaging and robotics to analyze and clean/refresh a worn pair of shoes provided by a consumer. More particularly, upon receiving a worn pair of shoes from a customer/user, the present system may scan the shoes to both determine the physical construction of the shoe and to identify the presence of any dirt, debris, stains, or damage on the shoe. The system then uses a variety of cleaning/rehabilitation methods to refresh the shoe and ideally expand the shoe's longevity. It is estimated that an increase in the life/longevity of a pair of shoes by six months can result in up to a 66% reduction in the carbon footprint of a pair of shoes.

In addition to the cleaning and refurbishing of a worn pair of shoes, the present system also provides the ability to ordain that pair of shoes with one or more ancillary objects, embellishments, or decals, which may be selected by the user through a provided user interface. Such adornments can include, for example, gems, rhinestones, studs, patches, decals, and/or other appliqués that may be fused to the shoe following the cleaning process. In doing so, the user may customize the look and feel of the shoe according to their own stylistic preferences. In some embodiments, these applied adornments may serve a commemorative function, such as by commemorating a user's visit to a notable store location (e.g., a flagship store) or by commemorating a notable temporally linked event/occurrence. For example, on the day of the Olympic opening ceremonies, a particular patch or decal may be made available to correspond to those games.

In further configurations of the present technology, applied adornments may include one or more digital identifiers that can link the user to a digital collectable. As part of the refurbishment process, this digital collectable may be gifted or sold to the user via that provided digital code. Such a digital collectible may include, for example, a cryptographically secured digital image or model that is uniquely recorded on a distributed Blockchain ledger. In some configurations, the digital image or model may resemble a shoe similar what was cleaned, or may have a look/appearance similar to a commemorative patch/decal applied to the physical shoe (e.g., which could then be applied as an adornment to a different digital collectable). In still other configurations, the digital collectable may be an accessory or item that may be used within a virtual world, or may be a performance modifier that may alter how a digital item behaves within a virtual environment/virtual world.

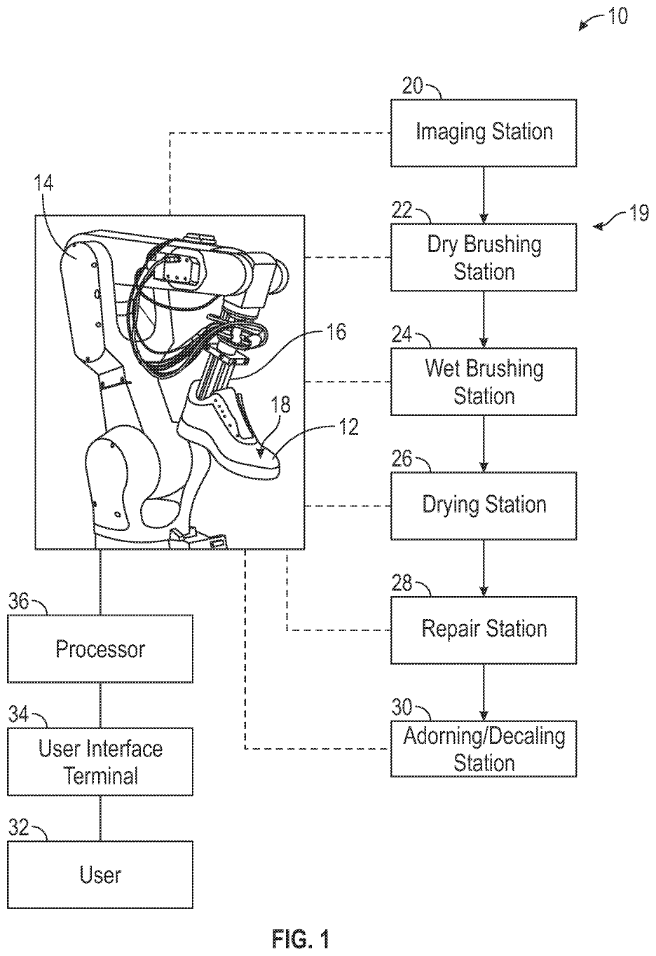

Referring to the drawings, FIG. 1 schematically illustrates a system 10 for cleaning and/or rehabilitating an article of footwear 12 (i.e., generally referred to herein as a “shoe 12”). In this illustrated configuration, the system 10 is largely constructed around a multi degree of freedom robotic arm 14 that carries a last 16 at a distal end portion 18. As used in the footwear industry, a last 16 is a fixture that often resembles a dimensional model of a foot/ankle and that can receive and support the shoe 12 throughout a number of subsequent processes. In some embodiments, the last 16 held by the robotic arm 14 may be a discrete tool that the robot can select according to the nature and size of the shoe 12 provided by the consumer. More specifically, following any initialization by the user, the robotic arm 14 may select the appropriately sized last 16 from a collection of differently sized lasts prior to starting the cleaning process. Alternatively, in some configurations, the last 16 may be a dynamically resizable fixture that is operative to change dimensions to receive and support shoes of varying sizes and physical constructions. Such dynamic resizing may occur, for example, using one or more mechanically expanding segments that can be moved using screws, gears, linkages, hydraulics, or pneumatics to achieve a desired pressure contact against an interior surface of the shoe 12.

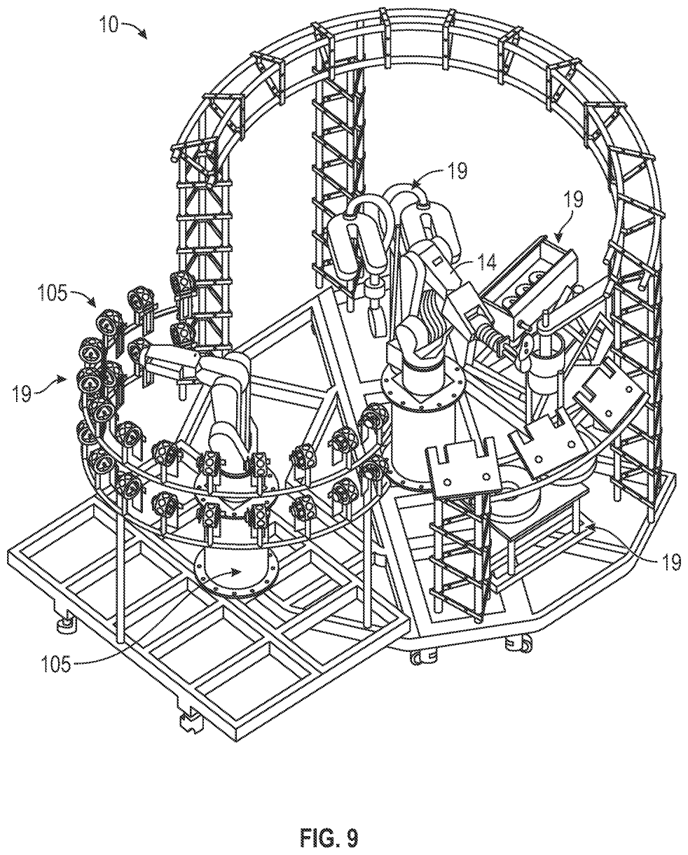

During operation, the robotic arm 14 may cycle or transition the shoe 12 through a variety of different stations 19 (as also/alternatively illustrated in FIG. 9) or processes that are each intended to perform a different process on the shoe 12. Each station may include different specialized equipment that may be used when performing the designated process. As shown in FIG. 1 examples of different functional stations include, for example, an imaging station 20, a dry brushing station 22, a wet brushing station 24, a drying station 26, a repair station 28, and/or an adorning/decaling station 30. Aspects of this process may further rely on the input or decision making from a user 32 via a user input terminal 34 in digital communication with a main process controller 36. The user input terminal 34 may also serve to provide the user 32 with a real time narration of the processes that are taking place.

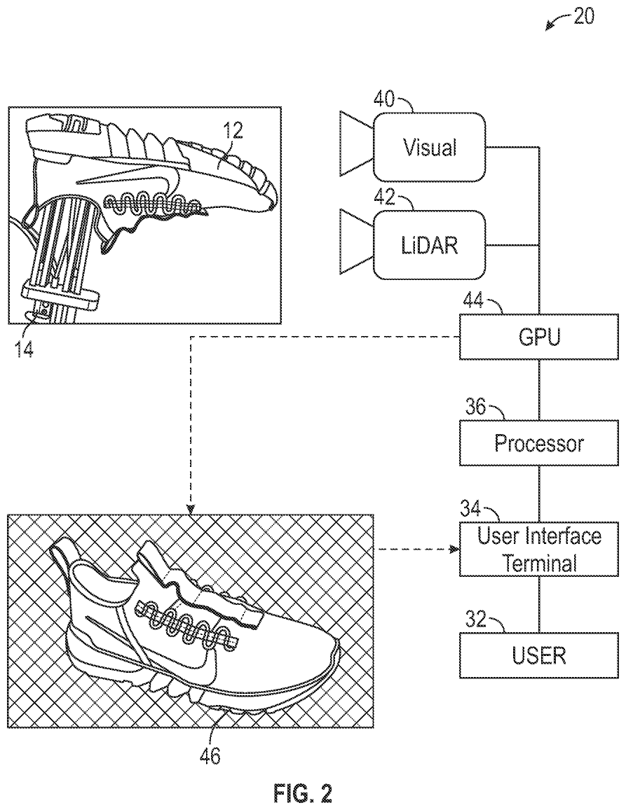

FIG. 2. systematically illustrates one embodiment of an imaging station 20. In general, the imaging station may be used to recognize the physical structure and condition of the shoe 12 so that subsequent processes may be more uniquely tailored to that particular shoe 12 and its needs. More specifically, knowledge of the physical structure (dimensions, materials, construction) may be used to position different cleaning tools more accurately relative to the shoe 12 and may even alter the nature of the cleaning processes according to the material being cleaned. Likewise, an understanding of the condition of the shoe 12 (e.g., presence of dirt, debris, stains, rips, tears, excessive wear, and the like) may also aid in selecting the appropriate cleaning processes and the duration of those processes to achieve a satisfactory outcome. The imaging station 20 may include one or more visible spectrum cameras 40, infrared spectrum cameras, ultrasound emitters/detectors, photogrammetry systems, and/or LiDAR sensors 42 to capture spatial and visible information of the shoe 12 (generally “imaging sources”). These imaging sources may feed into a designated imaging processor or GPU 44 that includes software/firmware that is operative to convert the scan/acquired image data into a suitable 3D annotated model 46.

In one configuration, the imaging station 20 may rely either on input from the user 32 or on optical image recognition techniques to estimate the entire physical structure of the shoe 12 (i.e., based on a catalog of known shoe constructions and/or machine learning techniques). In other embodiments, instead of relying purely on optical/visible spectrum sensing, the system 10 may utilize imaging sensors that rely on more direct measurement, such as by dimensionally modeling/scanning the physical shoe 12 using a LiDAR-type scanning process. As is well understood such a process constructs a shell model of the physical object by acquiring a multitude of three-dimensional data points on the surface of the object (via a laser-based sensing) and then wrapping/skinning these data points with a continuous surface/shell. Once the physical construction and size of the shoe is understood, the imaging station 20 may use optical detection methods to more aptly skin the model and/or identify the presence of dirt, debris, stains, damage, or excessive wear on the shoe. In some embodiments, optically recognized materials and/or cleanable contaminants may be identified within the model, such as via associated metadata, layers, and the like.

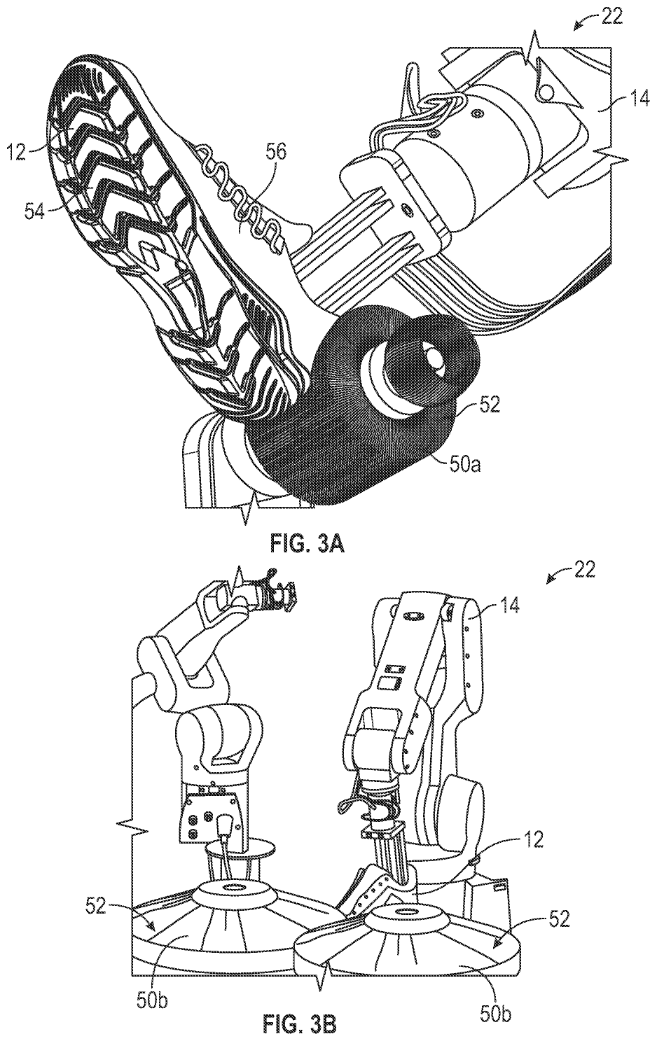

Referring again to FIG. 1, once the shoe 12 is sufficiently modeled via the imaging station 20, the robotic arm 14 may transition the shoe 12 to an optional dry brushing station 22 to begin the cleaning process. This dry brushing process may find particular utility if the imaging station 20 detected an overly dirty sole or dusty upper that may benefit from mechanical cleaning. As generally illustrated in FIGS. 3A-3B, the dry brushing station 22 may utilize one or more spinning/rotating bristle type brushes 50a, 50b to mechanically dislodge and remove dirt or debris on the shoe. In one configuration, the dry brushing station 22 may include a plurality of different brush types and/or stiffnesses and may be configured to select the appropriate brush based on the nature of the material to be cleaned (i.e., as determined via the imaging station 20). For example, in one configuration the stiffness of the bristles 52 may be selected according to the durability of the material that they will engage. In this manner, a stiffer brush/bristle (e.g., brush 50a in FIG. 3A) may be used when brushing the more rugged outsole 54, whereas a softer brush/bristle (e.g., brush 50b in FIG. 3B) may be required when brushing a knit material of the upper 56, which could be damaged by the stiffer brush.

Referring again to FIG. 1, following the dry brushing station 22, the robotic arm 14 may transition the shoe 12 to a wet brushing station 24 if stains or embedded dirt or contaminants remain. The wet brushing station 24 may utilize a process similar to the dry brushing, however it may incorporate the use of water, solvents, detergents, or other foaming or non-foaming cleaning agents to more deeply penetrate into the material and release embedded dirt/debris/discoloration. In one configuration, the nature of the cleaning agent may be selected according to the material being cleaned and/or the estimated composition and degree of the stain. Much like the dry brushing process shown in FIGS. 3A-3B, in some configurations the wet brushing may utilize one or more spinning/rotating bristle-type brushes to apply the cleaning solution and work it into the material. In other embodiments, the wet “brushing” station may not, in fact use a bristle-type brush, but rather may use a different type of “brush”, such as one or more wet cloths, sponges, or melamine foam-type cleaning tools. Further, the wet brushing station 24 may also be configured to select the appropriate brush (from a plurality of available brushes) based on the nature of the stain, the nature of the cleaning agent, and the material to be cleaned (i.e., as determined via the imaging station 20). While the wet brushing station 24 may utilized liquid baths, partially immersed brushes, and/or sprayers in an initial application/cleaning, it may also include one or more wiping cloths or absorbent brushes after the cleaning solution is applied to further the cleaning process and/or to remove liquid/dirt residue or excess lather (i.e., the wet brushing station 24 may include a wipe-off process).

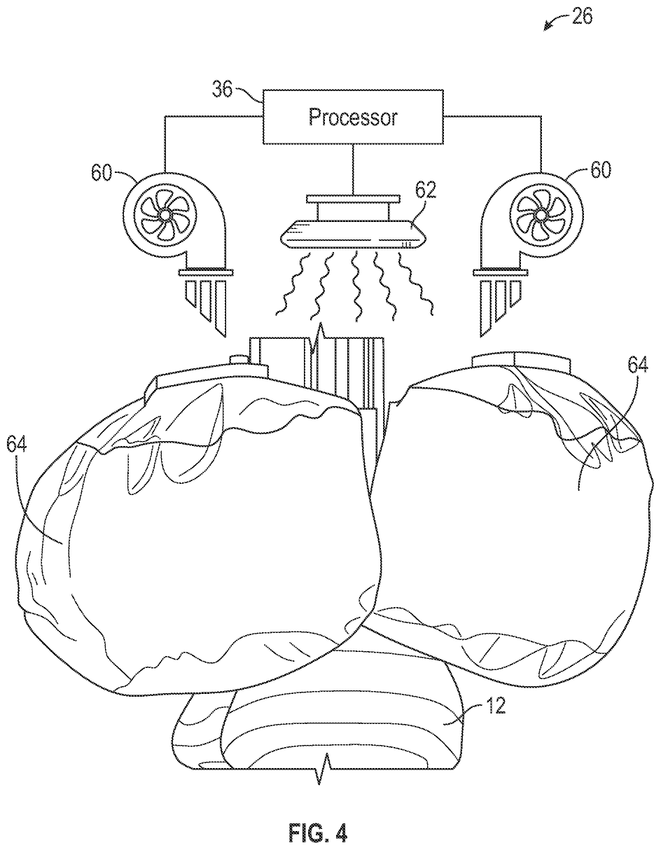

As further shown in FIG. 1, following the wet brushing station 24, the robotic arm 14 may transition the shoe 12 to a drying station 26 that may attempt to eliminate any residual/remaining moisture from the washing process. As generally shown in FIG. 4, the drying station 26 may utilize one or more blowers 60, suction, directed airflow, heated airflow, dehumidification systems, and/or infrared energy sources 62 to mechanically dislodge and/or evaporate any liquid that is held by the various materials of the shoe 12. In some embodiments, one or more baffles 64, air directors, or the like may be used to specifically direct airflow across and/or through the shoe 12.

Once the shoe 12 is dry, the robotic arm 14 may transition it back to the imaging station 20 for further analysis and to determine if any of the cleaning steps should be repeated. Additionally, the imaging station 20 may make a final assessment of structural damage that cannot be likely cured via cleaning. Following this assessment, if available, robotic arm 14 may transition the shoe to a repair station 28, whereby different fillers, adhesives, dyes, and the like may be selectively applied to the shoe in an effort to rehabilitate or reverse damage caused through ordinary wear.

While the preceding discussion identifies the various stations as being discreet and implies that they are physically separated, this need not be the case. For example, in some embodiments the present system may incorporate two robotic arms. The first arm 14 being the one which carries the last 16 and shoe 12, while a second robotic arm is configured to select different end effectors to perform the function of each described “station.” Said another way, this second arm may begin by picking up and utilize an imaging assembly, then may pick up a dry brushing end effector consisting of one or more spinning brushes, and so on. In still in other embodiments each station may be physically separate and have its own robotically controlled process while the shoe 12 and supporting last 16 is stationary/fixed on a carriage/gantry/trolley that can carry the target shoe from station to station. In further embodiments, one or more of the stations may be modified or omitted based on the condition of the shoe as sensed by the imaging station 20.

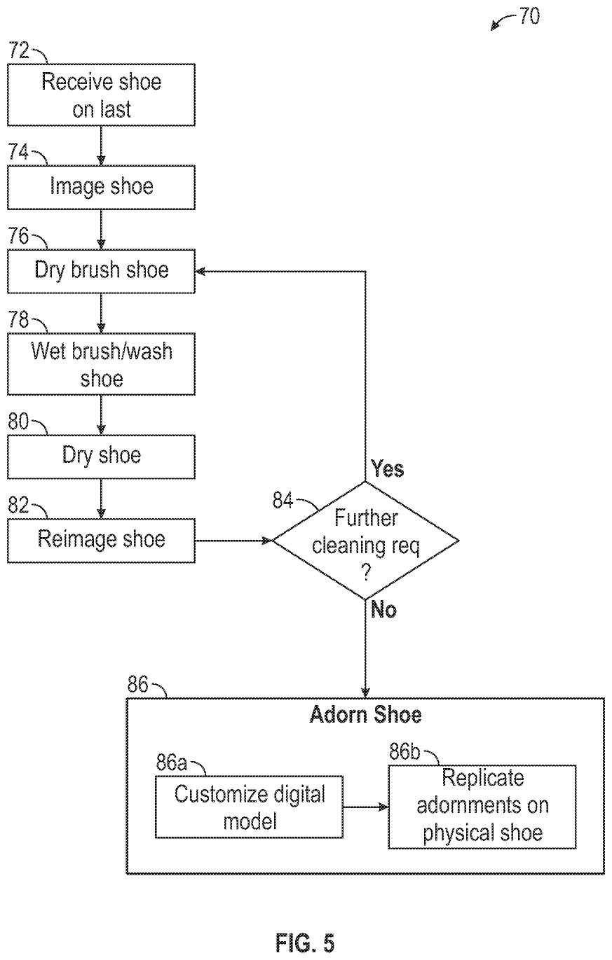

FIG. 5 generally provides a flow diagram illustrating a method 70 of retail engagement via an automated shoe cleaning process, similar to that discussed above. As shown, the method may begin at 72 with the system 10 receiving a shoe 12 from a user 32 onto an appropriately sized last 16. In general, “appropriately sized” is intended to refer to a last that makes contact with at least a majority of the inner surface of the upper of the shoe in a manner that can adequately support the material throughout subsequent cleaning processes. In one configuration this may involve selecting an appropriately sized last from a collection of different lasts according to the size or construction of the received shoe. In another can figuration, the last may be a dynamically sized fixture that can adjust in one or more dimensions to fill an internal volume of the shoe.

Once the shoe 12 has been received on the last at 72, the shoe 12 may be imaged at 74. In such a process, one or more imaging devices may scan the shoe 12 to both structurally model the shoe and to visually identify the material construction and presence of dirt debris stains or damage on the shoe 12. Using the output from the imaging processes the system may then attempt to mechanically dislodge any dirt or debris via a dry brushing process at 76 if such dirt or debris should exist. Dry brushing may involve mechanically contacting the exterior surface of the shoe with one or more mechanical elements, such as rotating bristle brushes for the purpose of removing any caked on dirt/debris.

Following the dry brushing process (76), the system may then attempt to wash any remaining dirt, debris, or stains from the material through a wet brushing process at 78. This may involve similar brushing mechanics as the dry brushing process (e.g., rotating and/or spinning brushes with varying bristle stiffnesses according to the material), though may include the use of water, detergents, solvents, or other cleaning products to penetrate deeper into the material.

After any required wet brushing at 78, the shoe may proceed to a drying process (at 80) to remove any remaining/residual liquid from the wet brushing process. Once dry, in some embodiment, the shoe may be re-imaged (at 82) to determine if further cleaning is required (at 84). This determination may be performed by a processor with suitable image recognition software. In one configuration, this determination may be performed by comparing the later in time scan with a prior scan to identify the degree of cleaning in the prior step, as well as to estimate the remaining amount of residual debris or contamination.

If the processor determines that further cleaning would be beneficial, (at 84) then one or more of the dry or wet brush and processes may be repeated. If further cleaning is not deemed to be beneficial, the method 70 may proceed to an optional to a damage repair process. Repairing damage may include, for example, robotically filling missing polymeric material (e.g., pits in the foam, missing outsole material, etc.), gluing together torn sections of foam, reconstructing elements that require more substantial reconstruction or replacement, or dying/bleaching any permanently discolored portions of the shoe.

In the interest of providing an engaging visual experience for the user, each of the above-mentioned steps may be performed using visually engaging processes, such as through the use of one or more multi degree of freedom robotic arms, spinning brushes, dynamic tool/end effector change-outs and the like. Further, during the performance of the various processes, a connected user display terminal 34 may provide synchronized infographics that describe what is transpiring.

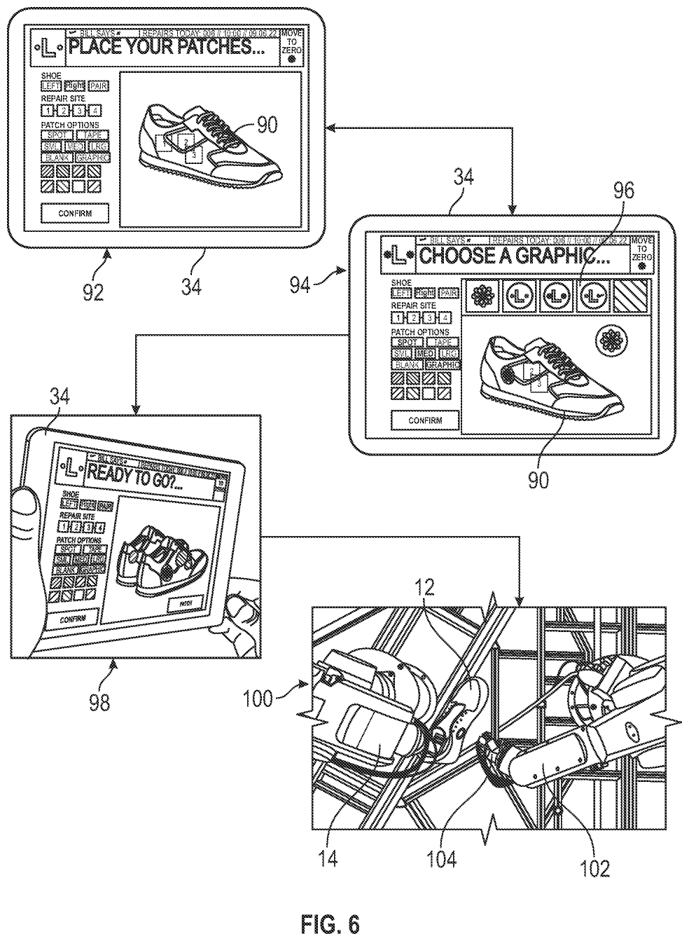

Following the cleaning process, the user may be provided the option of adorning their shoe with one or more embellishments, decals, or patches (at 86 in FIG. 5). This process may generally include the user first customizing an interactive digital model via the user interface terminal 34 (at 86a), followed by the system replicating the digital adornment on the physical shoe via one or more robotic processes (at 86b). This process is further illustrated in the schematic provided in FIG. 6.

As generally shown in FIG. 6, the step of customizing of an interactive digital model (e.g., 86a from FIG. 5) may begin with the system presenting the user with an interactive digital model 90 of their shoe 12 via the user interface terminal 34 (e.g., a tablet, connected smart phone, computer terminal or kiosk, etc.). Through this terminal 34, the processor 36 may provide the user with the ability to rotate the model 90 along with the ability to select the placement (at 92) and nature/graphic of the chosen adornment (at 94). In one configuration, a plurality of different adornments 96 may be presented to the user for selection/application. In some configurations, the digital model 90 may be a photo-realistic model that is acquired through the imaging process described above. In some embodiments, the processor 36 may constrain and/or limit the available adornment selection to a narrower subset of adornments based on predefined style guidelines or other physical constraints. For example, in one configuration, the processor 36 may restrict selections according to color palate or wear patterns (e.g., the user may be restricted from placing rhinestones directly on a ground-contacting outsole due to concerns over safety and durability). In other embodiments, the processor 36 may suggest the placement of decals or patches on the shoe to mend/patch existing structural damage, such as thinned material, scuffs, and/or rips or tears in the surface of the upper.

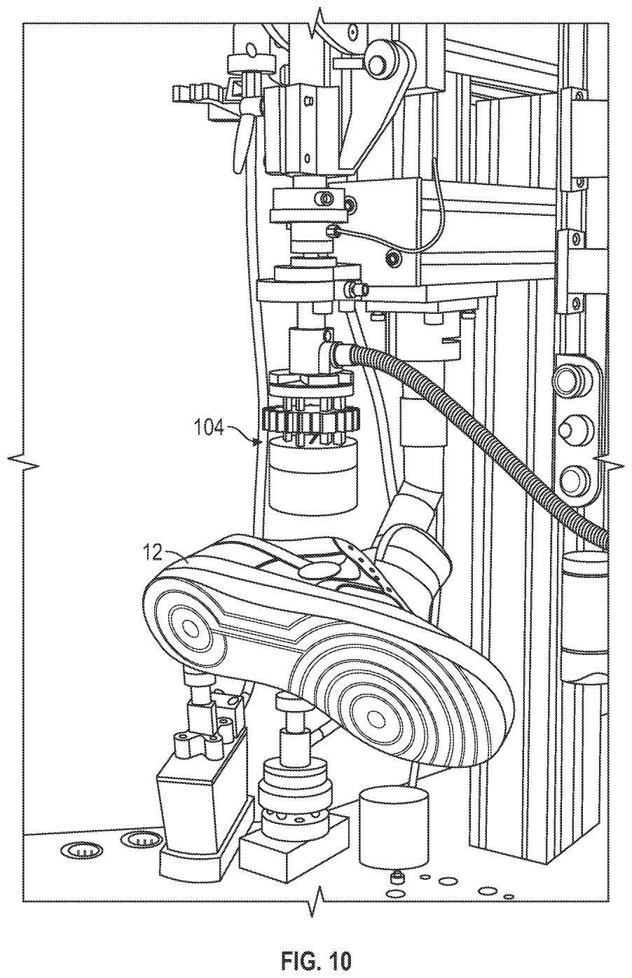

Once the user 32 has adorned the interactive model via the user interface terminal 34, they may submit the model to the processor 36 (at 98) whereby the processor 36 may then direct the one or more robotic systems/robotic arms to adorn the physical shoe 12 in a similar manner as the digital shoe (at 100). More specifically, the robotic arm 14 may transition the shoe 12 to an adornment station where a second robotic arm 102 or applicator 104 may pick the adornment off a corresponding roll (generally shown at 105 in FIG. 9) and then apply it to the shoe 12 at the designated location. In one configuration the adornment may include an adhesive backing that may either independently adhere to the material of the shoe upon contact (e.g., a tape adhesive or pressure sensitive adhesive), or may adhere/fuse with the material following the application of thermal or ultraviolet energy (i.e., where the energy may initiate a chemical bonding/curing process, or else may thermally weld the adornment to the material). FIG. 10 illustrates one embodiment of an applicator 104 or press-like device that may apply pressure and/or energy to secure the adornment to the shoe 12. In some embodiments, the applicator 104 may be configured to apply the adornment to the shoe may lightly dither in a side to side motion to cause the adornment to adhere and/or release from the applicator. In some embodiments, the applicator 104 may be selected from a collection of applicators to more closely match the contours of the shoe, as may be detected via an imaging modality such as photogrammetry (or any of the other above-discussed imaging sources). In other embodiments, complexity may be greatly reduced (likely at the expense of visual entertainment and overall retail engagement) if a compliant adapter were to be used to apply the adornment.

In some configurations, the adornment may include an embedded digital identifier or unlock code that can provide the user with secondary benefits from the cleaning/adornment process beyond simply receiving clean or adorned shoes. For example, in some configurations the digital identifier may be a discount code that can be used to redeem other merchandise/services from the store. Alternatively, this single use code may credit the user's account with virtual coins or points that the user may apply or redeem toward one or more digital trophies, levels, collectables, and/or experiences within a virtual marketplace. In some configurations, such points/credits may indicate a user's level of physical retail engagement, brand loyalty, and/or may reward a user for actively seeking to extend the life of their shoes, which has a net positive environmental impact.

The embedded digital identifier may have various forms depending on the nature of the adornment or application. For example, in one embodiment the digital identifier may be encoded in a visible image on a decal or patch. This may take the form of a QR code, barcode, unique pattern of digital camouflage, color selection at predefined points within an image, or the like. In another embodiment, the digital identifier may be encoded within an NFC tag that is integrated or embedded within the patch. In either case, it is preferable that a user can extract the code using accessible means, such as hardware or software functionality integrated into their smart phone. In the event of the code being embodied in a visible image, the user may rely on camera functionality within their phone to capture the image, after which a provided software decoder may analyze and decode the image into the alpha numeric digital identifier or code. Likewise, because NFC communication circuitry is incorporated into most smart phone devices, provided software would therefore be capable of communicating with an NFC tag in the patch for the purpose of receiving the digital identifier.

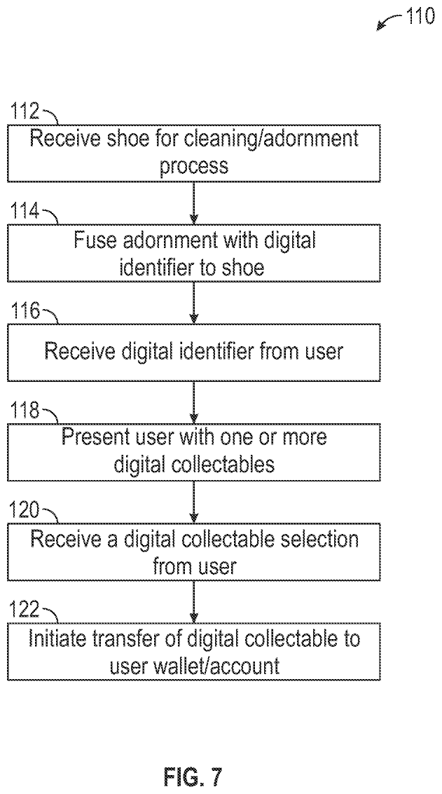

In one configuration the digital identifier embedded within the adornment may enable the user to mint, receive, or otherwise take ownership or possession of a cryptographically secured digital collectable. FIG. 7 generally illustrates a method 110 of distributing a digital collectible following the cleaning and/or adornment of an article of footwear. As generally illustrated, the method 110 begins when a user submits their physical article footwear to a cleaning/adornment process (at 112), such as described above. In this process, a robotic system may apply and fuse and adornment such as a decal or patch on the submitted article (at 114). The decal or patch may include an embedded digital identifier, which may be selectively decoded (at 106) via a software application running on the user's smart phone device or other portable computing device.

Once the digital identifier is decoded, the user may submit that code to a digital application running on an Internet connected server/device. Once the Internet connected device receives the digital identifier from the user (at 116), the Internet connected device may present the user (via the user's connected computing device) with one or more available digital collectibles that may be redeemed for the digital identifier (at 118). Such collectibles may include, for example, Proof of Attendance Protocol (POAP) NFTs, digital collectible images or models of the user's shoe, commemorative items, or other digital tokens or virtual currency. Received digital currency may be of the kind that can be accumulated or exchanged for other digital items, physical items, or merchandise discounts at a later time.

In one configuration, commemorative items that may be offered to the user may include, for example, virtual medal, trophies, or certificates recognizing the user's participation in the cleaning process or the user's presence at a particular retail location. Alternatively, these commemorative items may include memorabilia relating to a third-party event or occurrence taking place at a temporarily linked time (e.g., to commemorate, for example, the opening ceremonies of the Olympic Games). In some configurations, the received digital collectables may be part of a series or broader collection of collectables. In such an embodiment, the received digital collectable may be selected from the broader collection or series in a sequential manner, according to one or more temporal windows, randomly, according to probabilistic methods, according to the presence and/or digital attributes of other digital collectables in the user's digital wallet, according to the physical location of the cleaning and/or adorning, or through other similar methods. In some embodiments, if a user were to acquire all constituent digital collectables within a series, one or more additional opportunities, experiences, or digital collectables may be made available to the user.

If the offered digital collectible is an image or model of the user's shoe, the user may be presented with the option of taking the collectable in either an original/new state (as may be understood from a recognized make/model/year/colorway determined during the cleaning process), the worn state prior to cleaning (i.e., constructed directly from, or otherwise derived from pre-cleaning imaging), or the shoe in a worn, but cleaned state (i.e., which may be constructed directly from, or otherwise derived from post-cleaning imaging).

Once the user selects a desired item (i.e., the Internet connected device receives an indication of the selected item at 120), in one configuration, the Internet connected device may then initiate a transfer of the item to an account associated with, or otherwise belonging to the user (at 122). In one embodiment, such a transfer may include the transfer of a cryptographically secured record of the item to an associated digital wallet address of the user via the recordation on a distributed Blockchain ledger.

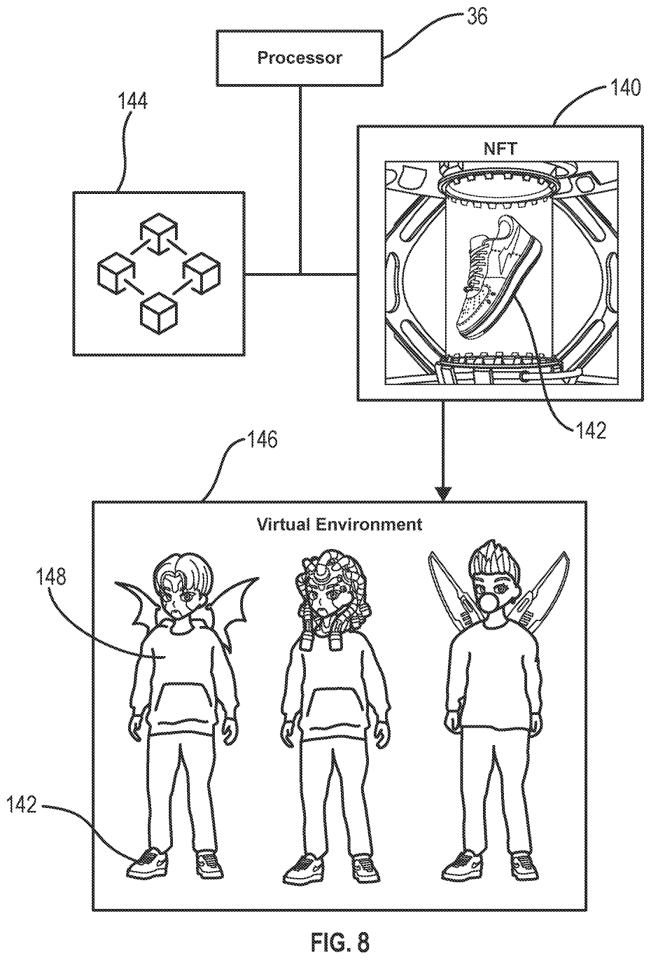

In some embodiments, the digital image or model of the user's shoe may be imported into video games, virtual environments, or virtual worlds where it can then be worn or otherwise used by a character avatar controlled by the user, such as shown in FIG. 8. More specifically, FIG. 8 schematically illustrates the processor 36 facilitating or instructing the creation and/or recordation of an NFT 140 comprising the digital image or model 142 (i.e., the digital collectable 142) on a corresponding distributed blockchain ledger 144. Once recorded or minted to the blockchain, the digital collectable (or 3D image files/models referenced by the NFT 140), may be downloaded and/or imported into a virtual environment 146, where the gaming program may allow a character avatar 148 to wear or otherwise use the shoe/collectable 142. As may be appreciated, the virtual environment 146 may be a video game or other software application that may be run either in an internet/cloud hosted space where the user can remotely play, or else on a console-type device where the graphics files of the shoe would get downloaded into the user's console for local gameplay. In further embodiments, this digital image or model 142 may be suitable to be expressed in the real world via an augmented reality viewer.

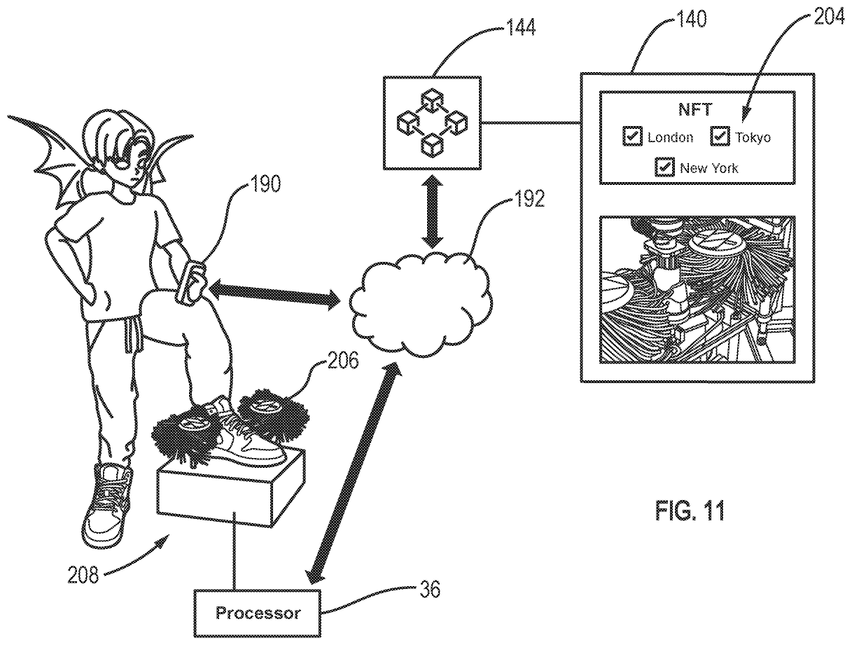

In one embodiment, the above-described cleaning process/method of retail engagement may be made available as a service to brand-loyal consumers as a reward for their participation or activity within the brand community. For example, in one configuration, the cleaning process may be made available for no charge to any user who has an existing user account with the brand. To accomplish this, in some configurations, aspects of the process, such as set up, input of the make or model of the shoe, or initiation of the process may take place within an application running on the user's smart phone 190 (such as shown in FIG. 11), which may be in direct or indirect wireless digital communication with the cleaning system, such as via a wireless communications network 192 (e.g., a wide area network (WAN) that includes any suitable infrastructure or computing devices. Such a network 192 may be any available type of network, including a combination of public distributed computing networks (e.g., Internet) and secured private networks (e.g., local area network, wide area network, virtual private network). It may also include wireless and wireline transmission systems (e.g., satellite, cellular network, terrestrial networks, etc.).

In another embodiment, such as schematically illustrated in FIG. 11, one or more aspects of the cleaning process may be made available as an NFT gated process that may require the user to have possession of a particular NFT 140 within a digital wallet or user account on a distributed blockchain ledger 144 or other similar public or private blockchain or database. In this manner, ownership of the NFT 140 may be the equivalent of a membership pass that, based on the rarity tier of the NFT or other associated badges 204, may permit a predefined number of cleanings within a given stretch of time. In some embodiments, the badges 204 may be directly recorded in metadata of the NFT 140, and they may either be absolute or modifiable. For example, in one configuration, the NFT 140 may be originally minted with the entirety of the access badges that it will ever have, and those access rights may live on for the duration of the NFT's existence. In other embodiments, upon use, the NFT itself may be “burned” or sent to a burn-wallet or else the badges themselves may be marked as used in metadata. In still other embodiments, the badges 204 may be sub-asset NFTs that are referenced in metadata by the NFT 140. Upon use, the sub-asset NFT badge may be individually burned without affecting the more senior NFT 140. Such a nested or layered approach to NFT usage is described in U.S. Pat. No. 11,475,449, which is incorporated by reference in its entirety and for all that it discloses.

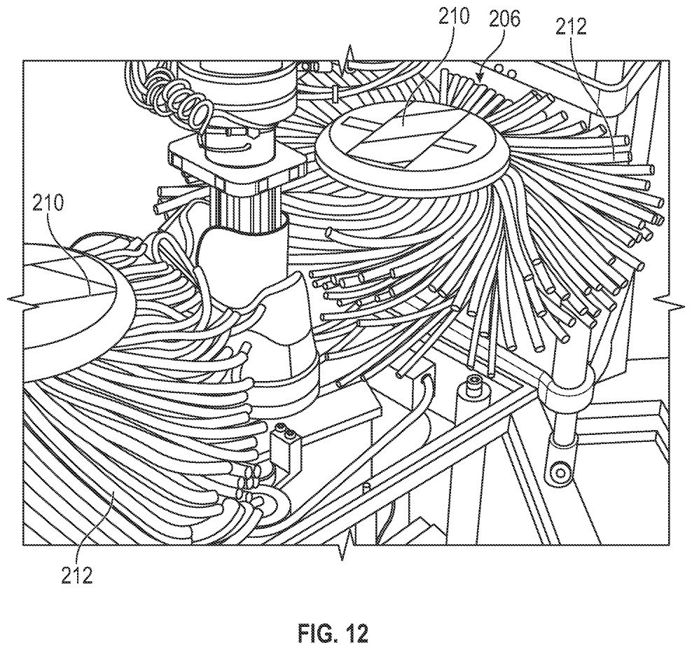

As further illustrated in FIG. 11, isolated portions of the cleaning process, such as an innovative brushing/wiping device 206 may be utilized as stand-alone token gated cleaning system 208. For example, as generally illustrated in FIG. 11 and in further detail in FIG. 12, in one configuration the brushing/wiping device 206 may include one or more rotating brushes 210 that are made from virgin or recycled shoelaces 212. If the process is used in a wet context, the device 206 may further include a beater bar that uses the contact between the laces and the bar to wring out any liquid and restore the absorbency of the lace material.

While the present disclosure is made specifically in reference to articles of footwear, such examples should be regarded as illustrative of a more general system for retail engagement and/or distribution of digital collectables through a product ornamentation/adorning process. It is specifically contemplated that this process may similarly be used with other retail-based consumer goods, such as articles of clothing, such as hats, short sleeve t-shirts, long sleeve t-shirts, sweatshirts, pants, or jackets, accessories, such as bags or back packs, sporting equipment such as golf clubs, personal protective gear/padding, mountain bikes, and the like. In each case, the article may be fixtured with a suitable fixture (i.e., where a last may be appropriate for an article of footwear, a sweatshirt may more appropriately be supported by a small table or mannequin). Further, not all portions of the cleaning process may be strictly required or even available depending on the nature of the article. In some embodiments, the process may be specifically limited to the adornment process, and may omit the cleaning altogether. Particularly within the footwear industry, the cleaning processes, however, may have particular applicability with certain cleated footwear or hiking boots that may tend to have grass or other dirt/debris impacted between cleats/lugs.

As noted above, the present technology presents an interactive and visually stimulating manner of engaging with customers within physical retail environments. As used herein, the notion of a retail environment or establishment is intended to refer to any physical space where prospective customers are offered one or more goods or services in exchange for some form of currency. In many instances, retail establishments may take the form of physical, brand-specific stores, however, it may also include kiosks, booths, or portions of event venues where the consuming population may be present. It should be noted that, while it is preferable for maximum customer engagement to perform the cleaning and/or adorning process entirely within the retail establishment, doing so is not strictly required. Said another way, unless otherwise specified, one or more steps in the cleaning and/or adorning process may be performed outside of the retail establishment or view of the consumer/user wile still satisfying the objectives of an increased level of consumer retail engagement.

Aspects of this disclosure may be implemented, for example, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of non-transitory memory devices in digital communication with the controller. Non-transitory memory may include, for example and without limitation, magnetic disk based hard drives and/or solid-state drives that include one or more types of flash memory.

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software or a combination thereof, in a computer system or other processing system.

As noted in the disclosure, the present system may utilize public or private blockchain infrastructures, distributed ledgers, append-only databases, and the like. In one example, the presently described cryptographically secured digital assets may initially be stored/secured to a private blockchain that resides on infrastructure maintained by a single entity, or consortium of entities. Each entity may agree upon a common form, or data construct for the infrastructure, though assets of any one entity may be maintained by that entity. Such a model may provide for the sharing of network and infrastructure costs/resources, while permitting each entity to maintain their own asset independence. To further public trust, assets created on this private or semi-private blockchain may be transferrable to public chains at the discretion of the user (potentially subject to one or more conditions of transfer).

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a hard drive, or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

Further aspects and embodiments of the present disclosure are provided in the following listing of clauses, which should be read in light of the disclosure above:

Clause 1. A method of retail engagement comprising: receiving a worn article from a user in a retail establishment, the worn article including dirt or debris on an outer surface of the article; imaging the worn article to determine a structure of the worn article and a location of the dirt or debris on the outer surface of the article; robotically brushing the article with the first brush at the determined location to dislodge at least a portion of the dirt or the debris, wherein the first brush is a dry brush; robotically brushing the article with a second brush at the determined location to further remove the dirt or the debris, wherein the second brush is a wet brush comprising a liquid water, detergent, and/or solvent; and drying the article to remove any of the liquid water, detergent, and/or solvent remaining following the brushing with the second brush.

Clause 2. The method of clause 1, further comprising selecting the first brush from a plurality of first brushes each having a different bristle type and/or stiffness, wherein the selected first brush has a bristle type and/or stiffness that is chosen according to the determined structure of the worn article at the location of the dirt or debris.

Clause 3. The method of clause 1, wherein determining the structure includes determining a physical structure and determining a material type of the worn article.

Clause 4. The method of clause 3, wherein the imaging includes imaging the worn article with a LiDAR system to determine the physical structure, and imaging the worn article with a visual camera to determine the material type and location of the dirt or debris.

Clause 5. The method of clause 1, wherein the worn article is an article of footwear having an upper and a sole structure, and wherein receiving the worn article from the user comprises receiving the article of footwear on a last such that the last extends between the upper and the sole structure.

Clause 6. The method of clause 5, further comprising transitioning the worn article and last from the first brush to the second brush, and from the second brush to a drying station using a multi-degree of freedom robotic arm.

Clause 7. The method of clause 1, further comprising, subsequent to the removing of the dirt or debris, adorning the outer surface of the article with one or more adornments, the one or more adornments being selected by the user.

Clause 8. The method of clause 7, further comprising: presenting the user with a digital image or model of the worn article via a user interface device; receiving, from the user via the user interface device, an indication of a placement location for the one or more adornments on the digital image or model; receiving, from the user via the user interface device, a selection of a chosen adornment from a selection of available adornments; and wherein adorning the article with the one or more adornments comprises robotically placing the chosen adornment at a location on the worn article that corresponds to the placement location on the digital image or model.

Clause 9. The method of clause 8, further comprising presenting the user, via the user interface device, a digital collectable that includes the digital image or model of the worn article.

Clause 10. The method of clause 8, wherein the chosen adornment includes a digital identifier; the method further comprising: receiving the digital identifier from the user; following the receipt of the digital identifier from the user, transferring or instructing the transfer of a digital collectable to an account or digital wallet of the user.

Clause 11. The method of clause 10, wherein the digital collectable includes the digital image or model of the worn article.

Clause 12. The method of clause 10, wherein the digital collectable includes a digital image or model of the chosen adornment.

Clause 13. The method of clause 10, wherein following the receipt of the digital identifier from the user, the method comprises: presenting a plurality of available digital collectables to the user; receiving a selection from the user of a desired digital collectable from the plurality of available digital collectables; and wherein transferring or instructing the transfer of the digital collectable to the account or digital wallet of the user includes transferring or instructing the transfer of the desired digital collectable to the account or digital wallet of the user.

Clause 14. The method of clause 10, wherein the digital collectable is cryptographically secured to a digital blockchain ledger as a nonfungible token.

Clause 15. A robotic system for cleaning a worn article of footwear in a retail environment, the worn article of footwear including dirt or debris on an outer surface of the article, the system comprising: a multi-degree of freedom robotic arm having a distal end portion with a last mounted thereon, wherein the last is operative to receive and support the worn article of footwear; an imaging station configured to capture a plurality of images the worn article of footwear on the last; a processor configured to receive the images and generate a digital dimensional model of the worn article of footwear, the digital dimensional model including an identification of a location of the dirt or debris; a dry brushing station including at least one rotatable bristle brush, wherein the processor is further configured to control the robotic arm to bring the location of the dirt or debris on the article of footwear into contact with the rotatable bristle brush; a wet brushing station including at least one rotatable wet brush that is wetted with a liquid water, detergent, and/or solvent; wherein, subsequent to the dry brushing, the processor is configured to control the robotic arm to bring the location of the dirt or debris on the article of footwear into contact with the rotatable wet brush; a drying station including at least one blower operative to expel a directed airflow, wherein, subsequent to the wet brushing, the processor is configured to control the robotic arm to bring the article of footwear into the directed airflow to remove or evaporate any remaining liquid water, detergent, or solvent.

Clause 16. The system of clause 15, further comprising an adornment station, the adornment station including a robotic applicator operative to apply one or more physical adornments to the outside surface of the article of footwear.

Clause 17. The system of clause 16, wherein the processor is further configured to: present the digital dimensional model of the worn article of footwear to a user via a user interface device; receive, from the user via the user interface device, an indication of a placement location for the one or more adornments on the dimensional model; receive, from the user via the user interface device, a selection of a chosen adornment from a selection of available adornments; and control the robotic arm and robotic applicator to apply the chosen adornment to a location on the article of footwear that corresponds to the placement location on the dimensional model.

Clause 18. The system of clause 17, wherein the processor is further configured to present the user, via the user interface device, a digital collectable that includes the dimensional model of the article of footwear.

Clause 19. The system of clause 17, wherein the chosen adornment includes a digital identifier; and wherein the processor is further configured to: receive the digital identifier from the user; following the receipt of the digital identifier from the user, transfer or instruct the transfer of a digital collectable to an account or digital wallet of the user.

Clause 20. The system of clause 19, wherein the digital collectable includes the dimensional model of the article of footwear or a digital image or model of the chosen adornment.

Clause 21. The system of clause 19, wherein following the receipt of the digital identifier from the user, the processor is configured to: present a plurality of available digital collectables to the user; receive a selection from the user of a desired digital collectable from the plurality of available digital collectables; and wherein transferred digital collectable is the user desired digital collectable.

Clause 22. A method of retail engagement comprising: receiving a worn article from a user in a retail establishment, the worn article including dirt or debris on an outer surface of the article; robotically cleaning the worn article to at least partially remove the dirt or debris on the outer surface, wherein the cleaning comprises contacting the shoe with a rotating brush, and wherein at least one of the worn article or the rotating brush is robotically manipulated to cause the contacting; and robotically adorning the outer surface of the article with one or more adornments, the one or more adornments being selected by the user.

Clause 23. The method of clause 22, wherein the selected adornment includes a digital identifier; the method further comprising: receiving the digital identifier from the user; following the receipt of the digital identifier from the user, transferring or instructing the transfer of a digital collectable to an account or digital wallet of the user.

Clause 24. The method of clause 23, wherein the digital collectable includes a digital image or model of the worn article.

Clause 25. The method of clause 24, further comprising imaging the worn article to generate the digital image or model, wherein the imaging comprises: imaging the worn article with a LiDAR system to determine a physical structure of the article; and imaging the worn article with a visual camera to determine a visual appearance of the article.

Clause 26. The method of clause 23, wherein the digital collectable includes a digital image or model of the chosen adornment.

Clause 27. The method of clause 23, wherein following the receipt of the digital identifier from the user, the method comprises: presenting a plurality of available digital collectables to the user; receiving a selection from the user of a desired digital collectable from the plurality of available digital collectables; and wherein transferring or instructing the transfer of the digital collectable to the account or digital wallet of the user includes transferring or instructing the transfer of the desired digital collectable to the account or digital wallet of the user.

Clause 28. The method of clause 23, wherein the digital collectable is cryptographically secured to a digital blockchain ledger as a nonfungible token.

Clause 29. The method of clause 22, further comprising: imaging the worn article to generate a digital image or model of the worn article; presenting the digital image or model of the worn article of footwear to a user via a user interface device; receiving, from the user via the user interface device, an indication of a placement location for the one or more adornments on the dimensional model; receiving, from the user via the user interface device, a selection of a chosen adornment from a selection of available adornments; and controlling a robotic applicator to apply the chosen adornment to a location on the article that corresponds to the placement location on the digital image or model.

Clause 30. The method of clause 29, wherein the imaging comprises: imaging the worn article with a LiDAR system to determine a physical structure of the article; imaging the worn article with a visual camera to determine a visual appearance of the article; and merging the physical structure with the visual appearance to generate the digital image or model.

Clause 31. The method of clause 22, wherein the article is an article of footwear.

Clause 32. The method of clause 22, wherein the article is an article of clothing.

Clause 33. The method of clause 22, further comprising fusing the adornment to the article via the application of thermal energy or ultraviolet light.

Clause 34. A method of distributing a cryptographically secured digital collectable, the method comprising: receiving a worn article from a user in a retail establishment; robotically adorning the outer surface of the article with one or more adornments, the one or more adornments being selected by the user and including a digital identifier; wherein the selected adornment includes a digital identifier; subsequent to the adorning, receiving the digital identifier from the user; following the receipt of the digital identifier from the user, transferring, or instructing the transfer of a cryptographically secured digital collectable to an account or digital wallet of the user.

Clause 35. The method of clause 34, further comprising: imaging the worn article to generate a digital image or model of the worn article; presenting the digital image or model of the worn article of footwear to a user via a user interface device; receiving, from the user via the user interface device, an indication of a placement location for the one or more adornments on the dimensional model; receiving, from the user via the user interface device, a selection of a chosen adornment from a selection of available adornments; and controlling a robotic applicator to apply the chosen adornment to a location on the article that corresponds to the placement location on the digital image or model.

Clause 36. The method of clause 35, wherein the imaging comprises: imaging the worn article with a LiDAR system to determine a physical structure of the article; imaging the worn article with a visual camera to determine a visual appearance of the article; and merging the physical structure with the visual appearance to generate the digital image or model.

Clause 37. The method of clause 34, wherein the cryptographically secured digital collectable includes the digital image or model of the worn article.

Clause 38. The method of clause 34, wherein the digital collectable includes a digital image or model of the chosen adornment.

Clause 39. The method of clause 34, wherein following the receipt of the digital identifier from the user, the method comprises: presenting a plurality of available cryptographically secured digital collectables to the user; receiving a selection from the user of a desired cryptographically secured digital collectable from the plurality of available cryptographically secured digital collectables; and wherein transferring or instructing the transfer of the digital collectable to the account or digital wallet of the user includes transferring or instructing the transfer of the desired digital collectable to the account or digital wallet of the user.

Clause 40. The method of clause 34, wherein the article is an article of footwear.

Clause 41. The method of clause 34, wherein the article is an article of clothing.

Clause 42. The method of clause 34, further comprising fusing the adornment to the article via the application of thermal energy or ultraviolet light.

1. A method of retail engagement comprising:
receiving a worn article from a user in a retail establishment, the worn article including dirt or debris on an outer surface of the article;
robotically cleaning the worn article to at least partially remove the dirt or debris on the outer surface, wherein the cleaning comprises contacting the shoe with a rotating brush, and wherein at least one of the worn article or the rotating brush is robotically manipulated to cause the contacting; and
robotically adorning the outer surface of the article with one or more adornments, the one or more adornments being selected by the user.

2. The method of claim 1, wherein the selected adornment includes a digital identifier;
the method further comprising:
receiving the digital identifier from the user;
following the receipt of the digital identifier from the user, transferring or instructing the transfer of a digital collectable to an account or digital wallet of the user.

3. The method of claim 2, wherein the digital collectable includes a digital image or model of the worn article.

4. The method of claim 3, further comprising imaging the worn article to generate the digital image or model, wherein the imaging comprises:
imaging the worn article with a LiDAR system to determine a physical structure of the article; and
imaging the worn article with a visual camera to determine a visual appearance of the article.

5. The method of claim 2, wherein the digital collectable includes a digital image or model of the chosen adornment.

6. The method of claim 2, wherein following the receipt of the digital identifier from the user, the method comprises:
presenting a plurality of available digital collectables to the user;
receiving a selection from the user of a desired digital collectable from the plurality of available digital collectables; and
wherein transferring or instructing the transfer of the digital collectable to the account or digital wallet of the user includes transferring or instructing the transfer of the desired digital collectable to the account or digital wallet of the user.

7. The method of claim 2, wherein the digital collectable is cryptographically secured to a digital blockchain ledger as a nonfungible token.

8. The method of claim 1, further comprising:
imaging the worn article to generate a digital image or model of the worn article;
presenting the digital image or model of the worn article of footwear to a user via a user interface device;
receiving, from the user via the user interface device, an indication of a placement location for the one or more adornments on the dimensional model;
receiving, from the user via the user interface device, a selection of a chosen adornment from a selection of available adornments; and
controlling a robotic applicator to apply the chosen adornment to a location on the article that corresponds to the placement location on the digital image or model.

9. The method of claim 8, wherein the imaging comprises:
imaging the worn article with a LiDAR system to determine a physical structure of the article;
imaging the worn article with a visual camera to determine a visual appearance of the article; and
merging the physical structure with the visual appearance to generate the digital image or model.

10. The method of claim 1, wherein the article is an article of footwear.

11. The method of claim 1, wherein the article is an article of clothing.

12. The method of claim 1, further comprising fusing the adornment to the article via the application of thermal energy or ultraviolet light.

13. A method of distributing a cryptographically secured digital collectable, the method comprising:
receiving a worn article from a user in a retail establishment;
robotically adorning the outer surface of the article with one or more adornments, the one or more adornments being selected by the user and including a digital identifier;
wherein the selected adornment includes a digital identifier;
subsequent to the adorning, receiving the digital identifier from the user;
following the receipt of the digital identifier from the user, transferring, or instructing the transfer of a cryptographically secured digital collectable to an account or digital wallet of the user.

14. The method of claim 13, further comprising:
imaging the worn article to generate a digital image or model of the worn article;
presenting the digital image or model of the worn article of footwear to a user via a user interface device;
receiving, from the user via the user interface device, an indication of a placement location for the one or more adornments on the dimensional model;
receiving, from the user via the user interface device, a selection of a chosen adornment from a selection of available adornments; and
controlling a robotic applicator to apply the chosen adornment to a location on the article that corresponds to the placement location on the digital image or model.

15. The method of claim 14, wherein the imaging comprises:
imaging the worn article with a LiDAR system to determine a physical structure of the article;
imaging the worn article with a visual camera to determine a visual appearance of the article; and
merging the physical structure with the visual appearance to generate the digital image or model.

16. The method of claim 13, wherein the cryptographically secured digital collectable includes the digital image or model of the worn article.

17. The method of claim 13, wherein the digital collectable includes a digital image or model of the chosen adornment.

18. The method of claim 13, wherein following the receipt of the digital identifier from the user, the method comprises:
presenting a plurality of available cryptographically secured digital collectables to the user;
receiving a selection from the user of a desired cryptographically secured digital collectable from the plurality of available cryptographically secured digital collectables; and
wherein transferring or instructing the transfer of the digital collectable to the account or digital wallet of the user includes transferring or instructing the transfer of the desired digital collectable to the account or digital wallet of the user.

19. The method of claim 13, wherein the article is an article of footwear.

20. The method of claim 13, wherein the article is an article of clothing.

21. The method of claim 13, further comprising fusing the adornment to the article via the application of thermal energy or ultraviolet light.
